(19) United States
(12) Patent Application Publication
(10) Pub. No.: US 2004/0017087 A1
(43) Pub. Date: Jan. 29, 2004

(54) Latch apparatus

(76) Inventors: Shawn Ayres, Rice Lake, WI (US); Michael W. Kondratuk, Cameron, WI (US); Holly Chen, Rice Lake, WI (US)

Correspondence Address: MERCHANT & GOULD PC, P.O. BOX 2903, MINNEAPOLIS, MN, 55402-0903, US

(21) Appl. No.: 10/371,239

(22) Filed: Feb. 20, 2003

Related U.S. Application Data
(63) Continuation of application No. 10/206,152, filed on Jul. 24, 2002, now abandoned.

(51) Int. Cl. E05B 3/00

(52) U.S. Cl. 292/165; 292/336.3

(57) ABSTRACT

Generally, the present invention relates to a door latch for a storm door that includes a non-metallic live bolt and a set of housing plates with support members integrally formed from the plates. One embodiment of the invention is a latch apparatus with a housing having first and second opposed plates. The plates are spaced apart from each other and secured to each other by support members that are formed from the plates. The apparatus also includes a live bolt that may be made of a polymer material and that is slidably mounted in the housing and actuated between an extended position and a retracted position. The live bolt hub is mounted in the housing and actuates the live bolt between extended and retracted positions. A dead bolt assembly is slidably mounted in the housing between a locked position and an unlocked position. Lastly, the apparatus includes a cam that in the housing between a first position and a second position to actuate the dead bolt assembly between extended and retracted positions.

### BACKGROUND OF THE INVENTION

1. Field of the Invention

The present invention is directed to a door latch, and in particular, to a latch for a storm door that includes a nonmetallic live bolt and housing plates with support members integrally formed from the plates.

2. Related Art

Door latches are well known and have been used for storm doors for years. Typically, door latches include a latch housing that contains and supports many of the latch components. A latch housing may include opposing plates that are spaced apart by support members. The plates are spaced apart so that components such as a latch live bolt or a latch dead bolt and their associated actuating members may be housed between the plates. Often, the support members also act as attachment members for securing the plates together. For example, a support member may include a threaded bore into which a fastener may be inserted to capture a plate against the support member. A support member may also include a deformable end that is inserted through an opening in a plate and then deformed to create an interference fit between the support member end and the opening. Further, the support members may act as a threaded “base” for receiving a fastener used to attach a latch faceplate to the latch housing. Thus, the support member may be required to serve several purposes for the door latch.

One perceived drawback with prior art door latches is that the support members acting between housing plates are separately formed and assembled pieces. As a result, the process of assembling the latch is complicated because of the small size of the support members and the need to secure the support members to each of the plates. The assembly process is further complicated when a support member must be aligned in a particular direction in the housing, for example, aligned to receive a fastener for attaching a latch faceplate to the latch housing. A latch with a simplified latch housing configuration and elements for securing the latch plates and support members together while accounting for additional door latch requirements would be an advancement in door latch designs.

A further advancement in door latches has been the use of alternative materials mounted on or integrated into a face of a latch live bolt to reduce wear, decrease cost, or reduce the weight of the live bolt. Typically, latch live bolts are composed of a metal or metal alloy material. Many metals used for live bolts are susceptible to galling and other forms of wear over time. As the live bolt experiences wear, the live bolt action between extended and retracted positions may be affected, for example, the live bolt may become stuck in an unwanted extended or retracted position. Therefore, a latch live bolt for a storm door that reduces wear would be advantageous.

The present invention addresses these as well as other problems associated with prior art door latches.

### SUMMARY OF THE INVENTION

Generally, the present invention relates to a door latch for a storm door that includes a non-metallic live bolt and a set of housing plates with support members integrally formed from the plates. One embodiment of the invention is a latch apparatus with a housing having first and second opposed plates. The plates are spaced apart from each other and secured to each other by support members that are formed from the plates. The apparatus also includes a live bolt that is slidably mounted in the housing and actuated between an extended position and a retracted position. The live bolt may be made of a synthetic material such as a polymer. A live bolt hub is mounted in the housing and actuates the live bolt between extended and retracted positions. A dead bolt assembly is slidably mounted in the housing between a locked position and an unlocked position. Lastly, the apparatus includes a dead bolt cam rotating through a short throw in the housing between a first position and a second position. Rotation of the cam in a first direction to the first position moves the dead bolt assembly to the locked position, and rotation of the cam in a second direction to the second position moves the dead bolt assembly to the unlocked position.

In a second embodiment of the invention, the latch apparatus includes the structure of the embodiment described above and further includes support members formed from the plates that act as a guide for the dead bolt, a stop for the cam, and a threaded base for receiving a fastener that attaches a face place to the apparatus housing.

These features of novelty and various other advantages that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

The invention may be more completely understood in consideration of the following detailed description of various embodiments of the invention in connection with the accompanying drawings, wherein like numerals represent corresponding elements throughout several views, in which:

FIG. 1 is a perspective view of a latch apparatus assembly, according to the principles of the invention;

FIG. 2 is a perspective, partially exploded view of the latch apparatus assembly of FIG. 1;

FIG. 3 is a perspective exploded view of the latch apparatus assembly of FIG. 1;

FIG. 4 is a perspective view of a first housing plate for the latch apparatus assembly of FIG. 1;

FIG. 5 is a side plan view of the first housing plate of FIG. 4;

FIG. 6 is a perspective view of a second housing plate for the latch apparatus assembly of FIG. 1;

FIG. 7 is a perspective view of a live bolt for the latch apparatus assembly of FIG. 1;

FIG. 8 is a perspective view of a live bolt hub for the latch apparatus assembly of FIG. 1;

FIG. 9 is a side plan view of the live bolt hub of FIG. 8;

FIG. 10 is a perspective view of a dead bolt assembly for the latch apparatus assembly of FIG. 1;

FIG. 11 is a rear plan view of the dead bolt assembly of FIG. 10;

FIG. 12 is a perspective view of a dead bolt cam for the latch apparatus assembly of FIG. 1;

FIG. 13 is a perspective partially exploded view of an alternative latch assembly embodiment having two cam stops and utilizing a mortise lock dead bolt cam.

While the invention is amenable to various modifications in alternative forms, the specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION OF THE PREFERRED EMBODIMENT

The present invention is believed to be applicable to door latches, for example, door latches for storm doors and screen doors. In particular, the present invention is directed to a door latch that includes a housing with first and second opposed plates where the plates are spaced apart from each other and secured to each other by support members formed from the plates. The latch apparatus also includes a live bolt that may be made of a synthetic material, for example, a polymer such as nylon. While the present invention may not be so limited, an appreciation of various aspects of the invention will be gained through a discussion of the examples provided below.

The latch apparatus of the present invention overcomes many of the shortcomings of the prior art by reducing the number of latch apparatus components that must be assembled and by simplifying the design and assembly of the latch apparatus. The present invention accomplishes these objectives by providing a pair of housing plates that have support members formed from the plates, for example, by stamping a particular plate design and bending the support members to a position perpendicular to the plates. The present invention also provides for a live bolt that resists wear, thus ensuring improved performance of the latch apparatus over an extended period of time.

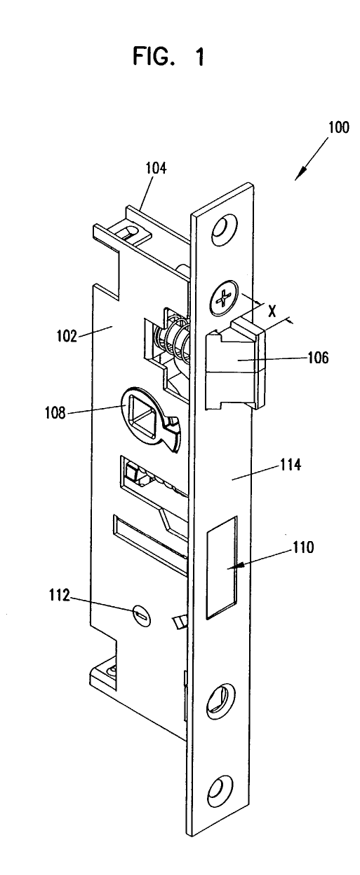

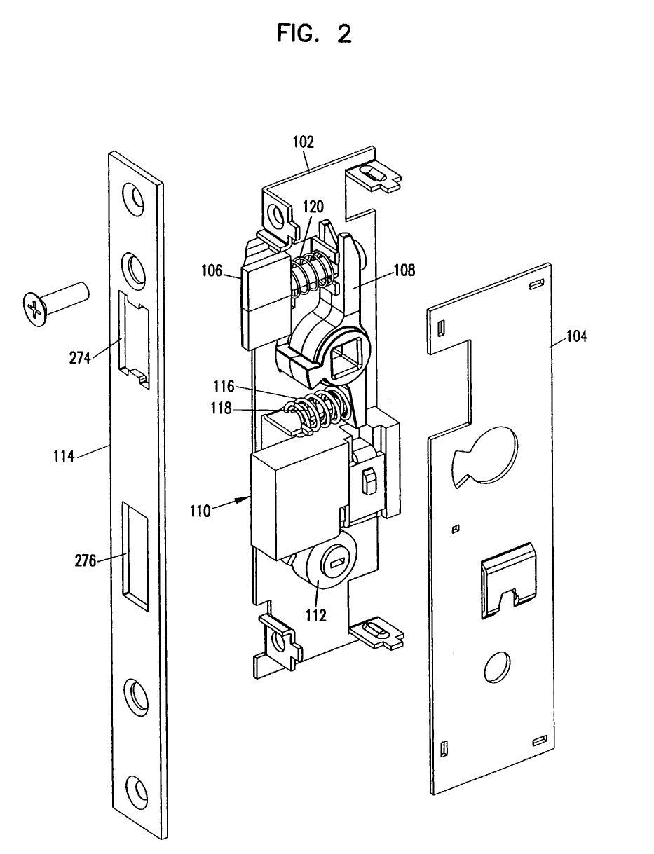

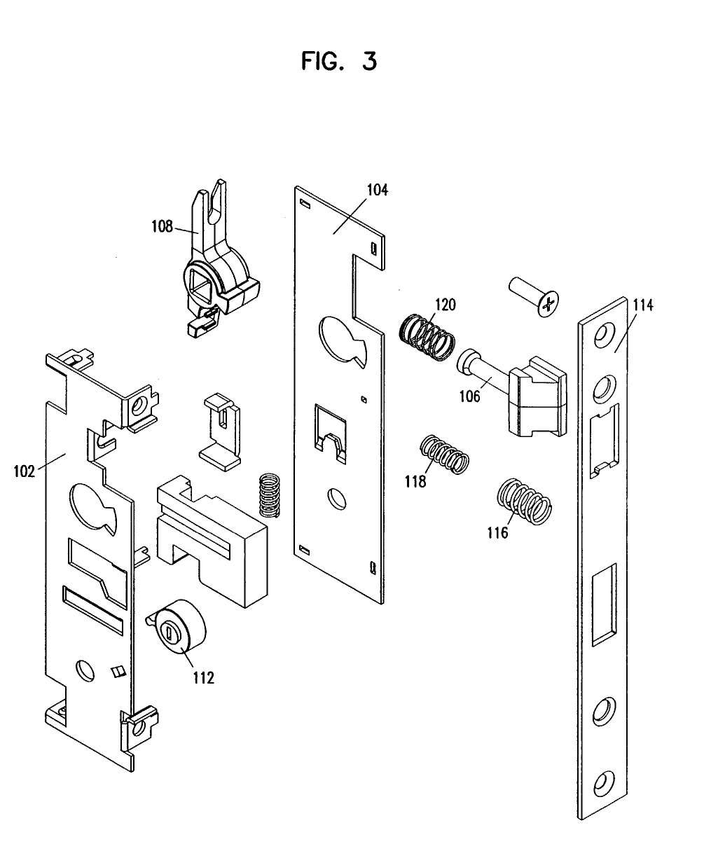

One example of a latch apparatus 100 of the present invention includes a first housing plate 102, a second housing plate 104, a live bolt 106, a live bolt hub 108, a dead bolt assembly 110, a dead bolt cam 112 and a faceplate 114, as illustrated in FIG. 1. FIGS. 2 and 3 further illustrate first and second hub springs (or biasing members) 116 and 118, and live bolt spring (or biasing member) 120. The features of these components will be described in further detail according to the following description of FIGS. 4-12.

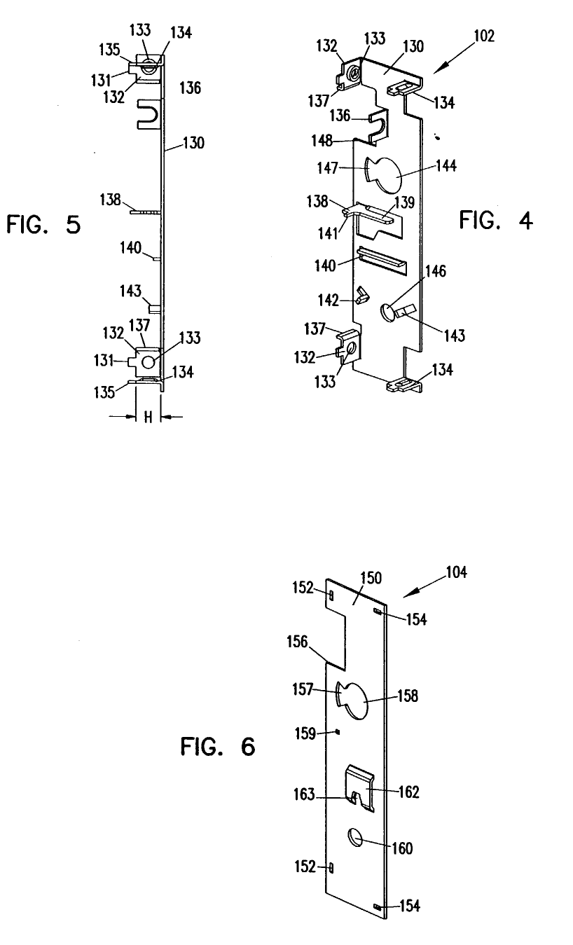

FIGS. 4 and 5 illustrate in detail first housing plate 102. First plate 102 includes a base member 130, lateral facing support members 132, longitudinal facing support members 134, live bolt support member 136, live bolt hub support member 138, dead bolt track 140 and cam stops 142 and 143. First plate 102 further includes live bolt hub opening 144, dead bolt cam opening 146 and live bolt opening 148.

Support members 132 and 134 are formed from base member 130. For example, all features of first plate 102 are formed from a single piece of material, such as a metal alloy sheet, so that the support members 132 and 134 and other features of plate 102 are monolithic with base member 130. The various support members and openings of plate 102 may be stamped into the sheet and in a separate step the support members are bent into a perpendicular position as support members. Support members 132, as shown in FIGS. 2-5, are positioned so that they face a side portion of latch apparatus 100. Support members 132 include a threaded opening 133 that may be used to receive a fastener, for example, a fastener to attach a faceplate to the latch apparatus as illustrated in FIGS. 1-3. Support members 132 also include an angled member 137 that extends at an angle relative to support members 132, as shown in FIG. 4. Angled members 137 assist in supporting a faceplate 114 that is attached to latch apparatus 100, and may strengthen support members 132.

Support members 134 face in a direction perpendicular to support members 132. Support members 134 may, in other embodiments, face the same direction as support members 132. Both support members 132 and 134 have a height H (see FIG. 5) that defines spacing between first and second housing plates 102 and 104. Support members 132 and 134 include attachment tabs 131 and 135 that, in the illustrated embodiment, extend through openings in second housing plate 104 (see FIG. 6). Attachment tabs 131 and 135 are made of a deformable material for the purposes of securing plates 102 and 104 together. When assembling plates 102 and 104 together, attachment tabs 131 and 135 are passed through associated openings in plate 104 and deformed to create an interference fit between the tabs, plate 104, and support members 132 and 134. Other embodiments may include alternative support member configurations and ways of securing plates 102 and 104 together using features of support members 132 and 134.

Live bolt support member 136 is formed to receive a portion of live bolt 106 to support live bolt 106 in its motion between extended and retracted positions. Live bolt support member 136 also serves as a surface against which live bolt spring 120 is captured and compressed during movement of the live bolt. Live bolt support member 136 further acts as a motion stop for live bolt hub 108.

Live bolt hub support member 138 includes a support arm 139 for capturing live bolt hub springs, and an attachment tab 141 similar to attachment tabs 131 and 135. Support member 138 is aligned parallel to the motion of live bolt 106 with arm 139 extending through a portion of live bolt hub 108 and capturing hub springs 116 and 118 between the live bolt hub 108 and support member 138. Attachment tab 141 extends through an opening in second plate 104 and is deformable to create an interference fit between attachment tab 141, second plate 104 and support member 138. Support member 138 cannot have a height greater than H, and preferably has a height H to assist in spacing first and second plates 102 and 104 a distance H apart.

Dead bolt track 140 typically extends in a direction parallel to the motion of dead bolt assembly 110 between extended and retracted positions. Dead bolt track 140 is configured to be inserted into a recessed portion of dead bolt 110 to provide dead bolt assembly 110 with a track or guide for moving between extended and retracted positions.

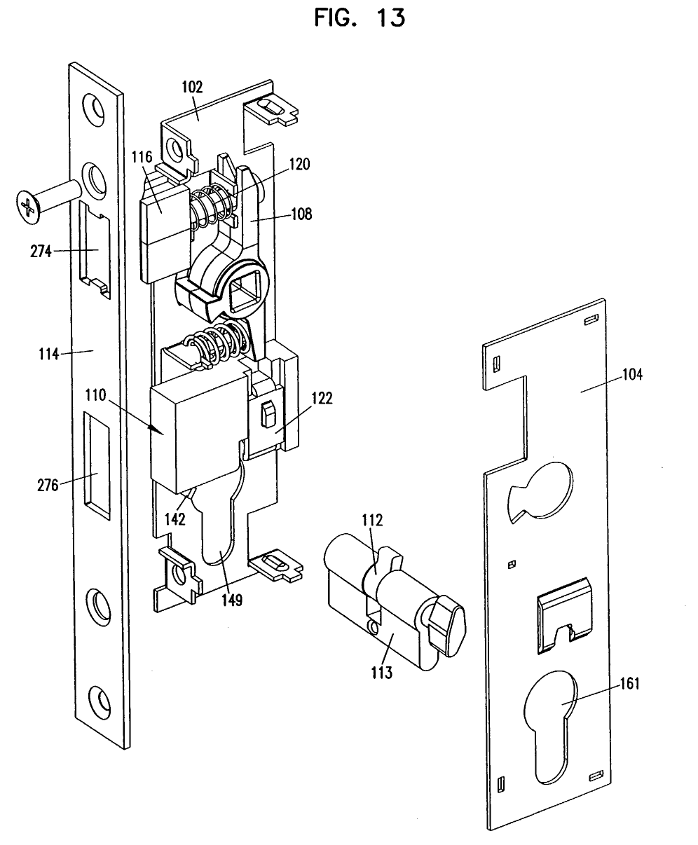

Cam stops 142 and 143 act as position stops for a deadbolt cam 112 and may be positioned in a variety of spaced positions around the circumference of opening 146 of first plate 102. Cam stops 142 and 143 may be placed at any desired location according to the design of dead bolt cam 112 and the desired angle of rotation of cam 112. Typically, cam stops 142 and 143 are positioned around opening 146 so that cam 112 is limited to a certain angle of rotation, for example, 60 to 180 degrees, and preferably about 90 degrees. In the alternative embodiment illustrated in FIG. 13, latch apparatus 100 includes a single cam stop 142.

First plate 102 also includes a live bolt hub opening 144 that is shaped to receive a portion of live bolt hub 108. Opening 144 includes an additional cam opening 147 (see FIG. 4). Cam opening 147 is configured to receive a cam extension of live bolt hub 108 and may act to limit the rotation of hub 108. The rotation angle of hub 108 may be limited by the size of cam opening 147 and/or the size of hub 108.

First plate 102 also includes a cam opening 146 to receive a portion of dead bolt cam 112. Cam stops 142 and 143 are typically positioned at a set distance from a center of cam opening 146, to coincide with the shape and size of a cam 112 (See FIGS. 2 and 3) acting within cam opening 146. Cam opening 146 is also positioned on base member 130 at a specified distance from dead bolt track 140 to account for the needed spatial relationship between dead bolt assembly 110 and dead bolt cam 112 for proper actuation of the dead bolt.

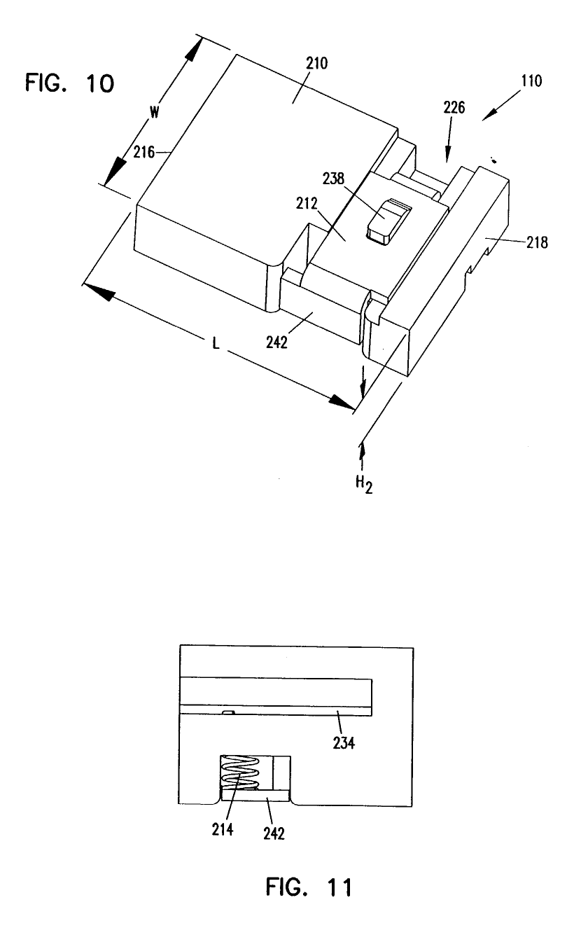

Referring now to FIG. 6, an explanation of second housing plate 104 is provided. Second plate 104 includes a base member 150, attachment openings 152 and 154, live bolt recess 156, live bolt hub opening 158, attachment opening 159 and dead bolt cam opening 160. Second plate 104 also includes a track cover 162 and a track tab 163. Cover 162 and tab 163 define spaced apart channels in which a follower of dead bolt assembly 110 may act to lock dead bolt assembly 110 in an extended or in a retracted position (see description of FIGS. 10-12).

Attachment openings 152 are configured to receive attachment tabs 131, attachment openings 154 are configured to receive attachment tabs 135, and attachment opening 159 is configured to receive attachment tab 141. As described above, the attachment tabs are inserted through attachment openings 152, 154 and 159. According to this embodiment, attachment tabs 131, 135 and 141 may be deformed under force to create an interference fit between the tabs, the attachment openings, and support members 132, 134 and 138. In other embodiments, both the attachment tabs and the attachment openings may be designed in a variety of different shapes and sizes, or may be replaced with other structure for securing a support member to a plate, as required for the present invention. For example, support members 132, 134 and 138 may be sized and configured to receive a fastener, such as a rivet or a screw that is inserted through second plate 104 to secure plate 104 to the support members.

Live bolt recess 156 is comparable in shape, size and position to live bolt recess 148 in first plate 102. Recesses 148 and 156 are intended to accommodate a variety of different sizes of live bolts 106 for a variety of different latch apparatus embodiments, and may therefore have other shapes and sizes from those illustrated in FIGS. 1-6.

Second plate 104 also includes a live bolt hub opening 158 with a an additional cam opening 157 that are aligned with and mirror the shape, size and position of live bolt hub opening 144 and cam opening 147 in first plate 102.

Dead bolt cam opening 160 is aligned with and mirrors the shape, size and position of dead bolt cam opening 146 in plate 1. Dead bolt cam opening 160 is also sized to receive a portion of dead bolt cam 112.

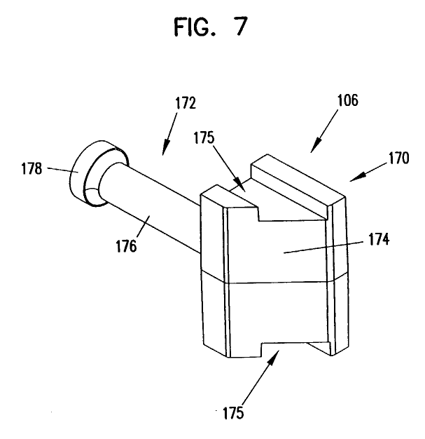

Referring now to FIG. 7, live bolt 106 is described and illustrated. Live bolt 106 includes a head portion 170 and a tail portion 172. Head portion 170 includes a face surface 174 and recesses 175 on opposing sides of head 170. Face surface 174, as described above, may be susceptible to wear over time. Wear can occur as the face surface of a live bolt head engages hardware in a doorframe. Other portions of the live bolt head may also be susceptible to different forms of wear as the live bolt moves into and out of recesses 148 and 156 of first and second plates 102 and 104 as well as an opening 274 in a faceplate 114 (see FIG. 2) attached to latch apparatus 100. In order to reduce galling and other forms of wear, live bolt 106 may be composed of, in whole or in part, synthetic material such as a polymer, metal, metal alloy, composites, ceramics, or any combination of these materials or other appropriate materials. Various types of polymers, such as nylon, may be particularly useful for reducing wear while retaining strength and durability of live bolt 106.

Recesses 175 in live bolt head 170 are included in live bolt 106 in order to provide a track or other guiding surface to ensure straight and smooth motion of live bolt 106 between extended and retracted positions. Recesses 175 engage protrusions extending into opening 274 (see FIG. 2) in faceplate 114.

Live bolt 106 also includes a tail portion 172 having an elongate member 176 that, on a first end attaches to head 170, and at a second end attaches to a cap 178. Member 176 is configured to receive a spring or biasing member 120 that acts between head 170 and live bolt support member 136. Such a spring 120 biases the live bolt 106 into an extended position, wherein a force is required to move live bolt 106 into a retracted position. Cap 178 is engaged by a portion of live bolt hub 108, as illustrated in FIG. 2, to force live bolt 106 into a retracted position. Cap 178 also assists in retaining live bolt 106 from extending beyond live bolt support member 136. Tail portion 172 may be made of the same or different materials from head portion 170. For example, the entire live bolt 106 may be made of a single material, such as a polymer, or may be made of several different materials that are secured, integrally formed, or cast together as a single monolithic part. In one embodiment, for example, tail portion 172 may be made of a metal alloy and head portion 170 may be made of a polymer material that is connected to tail portion 172, for example, with an adhesive. In a still further embodiment, the entire live bolt 106 may be made of a single cast piece of material such as metal, and surface 174 is made of a polymer material that is adhered to or snap-fit into place on head portion 170.

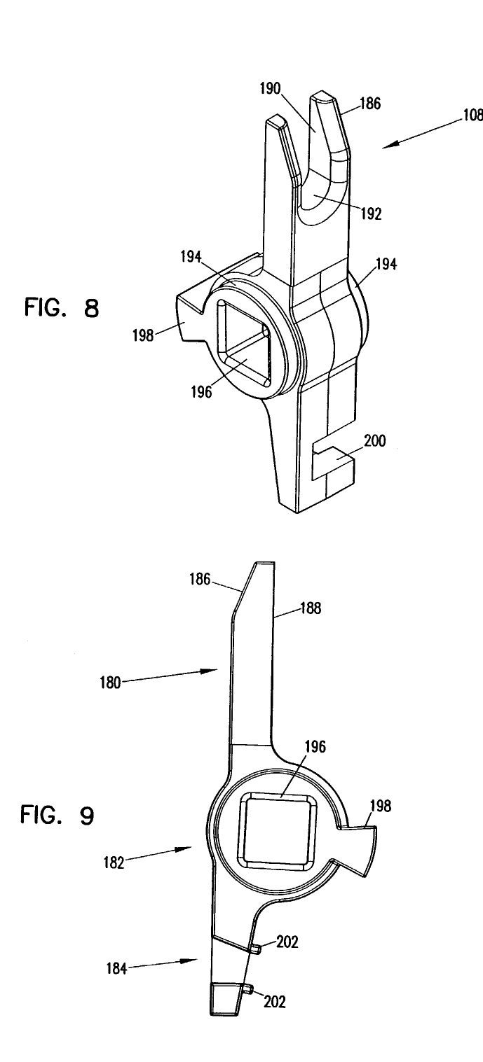

Referring now to FIGS. 8 and 9, live bolt hub 108 is illustrated and described. Live bolt hub 108 includes a live bolt engagement arm 180, a base member 182 and a rocker arm 184. Engagement arm 180 includes a cap engaging surface 186, a support member engaging surface 188, and a first slot 190 having a trough 192. Cap engaging surface 186 is slightly slanted relative to support member engaging surface 188 to provide a greater surface contact area between the live bolt hub and cap 178 of the live bolt as the live bolt moves between retracted and extended positions. In other embodiments, surface 186 may be parallel to support member engaging surface 188. Slot 190 and trough 192 are configured to receive elongate member 176 of live bolt 106. According to the illustrated embodiment, trough 192 and slot 190 are configured to receive a cylindrical elongate member, but in other embodiments slot 190 and trough 192 may be configured to receive different shapes of elongate members, for example, a rectangular shape.

Hub base 182 connects engagement arm 180 and rocker arm 184 and includes a cam extension 198 that limits rotation of the live bolt hub within hub openings 144 and 158 of the first and second plates, respectively. Hub base 182 also includes an actuation opening 196 for receiving an actuation member, such as a shaft attached to a rotatable handle. Opening 196 is configured to receive a square shaft in this embodiment, but may be configured to receive other shaft shapes such as a triangular or hexagon shaped shaft, so long as the actuation shaft is able to rotate (actuate) live bolt hub 108. Hub base 182 further includes protrusions 194 that engage hub openings 144 and 158 of the first and second plates. Protrusions 194 assist in positioning live bolt hub 108 properly between the first and second plates and provide contact surfaces for rotation of live bolt hub 108 in hub openings 144 and 158.

Rocker arm 184 of the live bolt hub includes a slot 200 that opens to a side of rocker arm 184 rather than being open to an end such as slot 190 on live bolt engagement arm 180. Slot 200 allows rocker arm 184 to be inserted over live bolt hub support member 138 and its associated support arm 139. Spring support members 202 are positioned along edges of slot 200 to capture springs 116 and 118 and to assist in maintaining alignment of springs 116 and 118.

Referring now to FIGS. 10 and 11, dead bolt assembly 110 is illustrated and described. Dead bolt assembly 110 includes a dead bolt 210, a follower 212, and a spring 214 acting between the dead bolt and the follower. Dead bolt 210 includes a first end 216, a second end 218, a width W, a length L, and a height H2. Dead bolt 210 also includes a recessed area 226 for receiving follower 212. Height H2 is no wider than height H of support members 132 and 134. Width W is typical of dead bolts in the art and is of a standard size to fit into an opening in both faceplate 114 and in a doorframe into which dead bolt 210 is inserted when the dead bolt assembly is in an extended position. The length L is variable.

Typically, dead bolt lengths are relevant as related to the distance X that dead bolt 110 extends beyond faceplate 114 (typically extending into a bore of the door frame) when the dead bolt is in a completely extended position (see FIG. 1). The distance X is commonly known as the “throw” of the dead bolt assembly. Distance X is commonly about ⅝ inch. However, this length has created some problems in practical applications of dead bolt assemblies in the art. For example, it is often the case that the bore in a doorframe that receives an extended dead bolt is not completely cleaned out. As a result, the dead bolt is unable to completely extend into the bore causing a “lockout” problem where the dead bolt is stuck in a partially extended position and is unable to be retracted. Such a “lockout” problem may be remedied in part by decreasing distance X to account for possible obstructions left in a bore of the doorframe. Thus, distance X, according to the present invention, may be shorter than ⅝ inch, or about 5/16 to 9/16 inch, and more preferably about ⅜ inch. This “short throw” (distance X less than the standard ⅝ inch common in the art) may possess the above stated advantages and may reduce the costs of manufacturing because less material is needed as compared to a standard throw.

Dead bolt 210 also includes a recessed track area 226 Track area 226 captures follower 212 and provide a surface against which spring 214 may bias follower 212 in a certain position. Dead bolt 210 also includes a track 234 that extends parallel to the direction of motion of dead bolt 210. Track 234 receives dead bolt support member 140 and acts as an alignment feature that assists in providing proper movement of dead bolt assembly 110 between extended and a retracted positions.

Follower 212 includes a protrusion 238 that acts within track cover 162 and track tab 163 of second plate 104. Spring 214 acts between dead bolt 210 and an end wall 242 of follower 212 to bias follower 212 in the illustrated position. Dead bolt cam 112 acts upon end wall 242 of the follower when actuating dead bolt assembly 110 between retracted and extended positions.

The components of dead bolt assembly 110 may be made from a variety of different materials, including, for example, metal, metal alloys, polymer materials such as high density polypropylene, ceramics, composites and the like. Most commonly, dead bolt 210 is made of a metal or metal alloy because of its need for high strength in locking a door in place. Follower 212, including protrusion 238, may be made of different materials than dead bolt 210, but must also have the properties of high strength and durability as protrusion 238 must resist wear from traveling over track tab 163 in second plate 104.

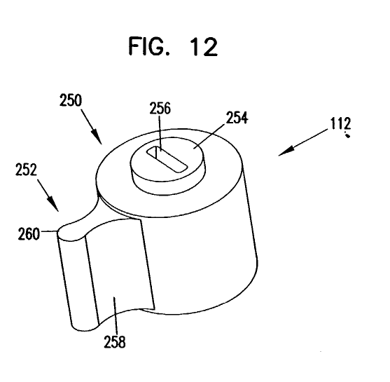

Now referring to FIG. 12, dead bolt cam 112 is described in detail. Dead bolt cam 112 may include a base portion 250 and a cam arm 252. Base portion 250 includes protrusions 254 and opening 256. Protrusions 254 extend through cam openings 146 and 160 of first and second plates 102 and 104, respectively. Protrusions 254 assist in aligning cam 112 relative to dead bolt assembly 110 and in securing cam 212 between plates 102 and 104. Opening 256 is configured to receive an actuating member of a key cylinder or the like that actuates cam 112 with a rotation motion.

Cam arm 252 includes an arm section 258 and a cam tip portion 260. Cam tip portion 260 engages wall portion 242 of follower 212 in the dead bolt assembly. Thus, as cam 112 is rotated, cam tip surface 260 actuates follower 212, pushing protrusion 238 over track tab 163 in second plate 104, thus moving dead bolt assembly 110 between a locked (extended) and an unlocked (retracted) position. Dead bolt assembly 1 10 cannot be retracted or extended without first moving follower 212 between an unbiased and a biased position due to actuation by cam arm 252 of cam 112. In other embodiments, follower 212 and all other feature of dead bolt assembly, do not engage features of the first and second housing plates for the purpose locking the dead bolt in locked or unlocked position.

The rotation of cam 112 may be controlled or stopped by cam stops 142 and 143 that may be positioned on an opposite side of cam opening 146 from each other to limit the angle of rotation of cam 112, for example, to 90 degrees. The reduced angle of rotation controlled by cam stops 142 and 143 may only be possible when using a specialized cylinder designed specifically for a reduced angle of rotation.

In addition to the cam embodiment that is actuated by a key cylinder, as illustrated in the FIGS. 1-6 and 12, cam 112 may be part of a mortise lock cylinder 113, as shown in FIG. 13. In such a configuration, first and second plates 102 and 104 may be modified to include larger openings 149 and 161 to account for the larger mortise lock cylinder body. In another embodiment, a thumb knob, key, or an electronic mechanism may actuate cam 112.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

We claim:

1. A latch apparatus, comprising:
a housing having first and second opposed plates, the plates being spaced apart from each other and secured to each other by support members formed from the plates;
a live bolt slidably mounted in the housing and actuated between an extended position and a retracted position;
a live bolt hub mounted in the housing, the live bolt hub actuating the live bolt;
a dead bolt assembly slidably mounted in the housing, the dead bolt assembly moving between a locked position and an unlocked position;
a cam rotating in the housing between a first position and a second position and actuating the dead bolt assembly between the locked position and the unlocked position.

2. The latch of claim 1 wherein the live bolt is made of a polymer material.

3. The latch of claim 1 wherein the live bolt comprises a head portion and a tail portion, the head portion comprising a polymer material.

4. The latch of claim 1 wherein the first plate comprises a support member formed from the first plate and the second plate comprises a support member formed from the second plate.

5. The latch of claim 1 wherein the first plate comprises support members formed from the first plate and the second plate has no support members.

6. The latch of claim 1 wherein the support members are monolithic with the first and second plates.

7. The latch of claim 1 wherein the support members are stamped from the plates and bent into a support position.

8. The latch of claim 1 further comprising a faceplate, wherein the dead bolt extends less than ⅝ inch from the faceplate when in a locked position.

9. The latch of claim 1 further comprising a first cam stop, wherein the cam stop limits rotation of the cam.

10. The latch of claim 9 further comprising a second cam stop, wherein the first cam stop limits rotation of the cam in the first direction and the second cam stop limits rotation of the cam in the second direction.

11. The latch of claim 1 wherein the dead bolt assembly comprises a dead bolt, a cam actuated member, and a biasing member acting between the dead bolt and the cam actuated member, wherein the cam actuates the cam actuated member to move the dead bolt assembly between locked and unlocked positions.

12. The latch of claim 1 wherein the live bolt comprises a head portion and a tail portion, and the latch further comprises a live bolt support member formed from the plates and a live bolt biasing member, and wherein the biasing member acts between the live bolt tail portion, the live bolt hub, and the live bolt support member.

13. The latch of claim 12 wherein the live bolt head portion comprises a polymer material.

14. The latch of claim 1 further comprising a hub support member formed from the plates and a hub biasing member, wherein the hub biasing member acts between the hub support member and the live bolt hub.

15. The latch of claim 14 wherein the hub biasing member comprises two biasing members.

16. The latch of claim 14 wherein the live bolt hub further comprises a rocker arm that engages the hub support member and the hub biasing member.

17. The latch of claim 1 further comprising a dead bolt support member formed in the plates, wherein the dead bolt support member slidably supports the dead bolt.

18. The latch of claim 1 wherein the dead bolt moves through a short throw.

19. A latch apparatus, the latch comprising:
a housing having first and second opposed plates;
support members formed from the plates and positioned between the plates for spacing the plates apart and securing the plates together;
a live bolt slidably mounted in the housing and actuated between an extended and retracted position, the live bolt comprising a polymer;
a live bolt hub mounted in the housing, the live bolt hub actuating the live bolt;
a dead bolt slidably mounted in the housing, the dead bolt moving between a locked position and an unlocked position; and
a cam rotating through a short throw in the housing between a first position and a second position and engaging the dead bolt;
wherein the support members further function to support the live bolt.

20. A method of assembling a latch apparatus, the latch apparatus comprising first and second opposed plates, a live bolt assembly, a live bolt hub, a dead bolt assembly, and a dead bolt cam, mounted in the housing, the method comprising the steps of:
forming support members from the first and second plates, the support members being monolithic with the first and second plates, the support members securing the plates together and spacing the plates a predetermined distance apart to form an apparatus housing;
actuating the live bolt between extended and retracted positions with the live bolt hub; and
actuating the dead bolt assembly between locked and unlocked positions with the dead bolt cam.
